(19) United States
(12) Patent Application Publication
(10) Pub. No.: US 2016/0283831 A1
(43) Pub. Date: Sep. 29, 2016

(54) RECORDING APPARATUS AND PROJECTION METHOD

(71) Applicant: SEIKO EPSON CORPORATION, Tokyo (JP)

(72) Inventors: Sumito ANZAI, Shiojiri-shi (JP); Norihiro YAMASHITA, Shiojiri-shi (JP)

(21) Appl. No.: 15/054,396

(22) Filed: Feb. 26, 2016

(30) Foreign Application Priority Data
Mar. 23, 2015 (JP) 2015-059164

(51) Int. Cl. G06K 15/02

(52) U.S. Cl. CPC G06K 15/1849; G06K 2215/101

(57) ABSTRACT

A recording apparatus includes a support unit that can support and move a medium toward the moving direction, a recording unit that records an image on the medium supported by the support unit based on digital data, and a projection unit that projects an object which is a reference of a recording position on the medium, on the medium supported by the support unit. By configuring the recording apparatus like this, it is possible to suppress the occurrence of the deviation between the recording position assumed from the digital data and the actual recording position.

### BACKGROUND

1. Technical Field

The present invention relates to a recording apparatus and a projection method.

2. Related Art

In the related art, various recording apparatuses have been used. In those recording apparatuses, there is a device in which a medium is supported by a medium support unit and recording can be performed on the medium supported by the medium support unit. In addition, in the recording apparatus like this, generally, the recording position on a medium is recognized by a user before the recording of an image, and then the recording position is adjusted.

For example, in JP-A-2005-41146, a recording apparatus is disclosed, in which a recorded medium (medium) supported by a platen (medium support unit) is read by image reading means and the recording position is adjusted based on the read position of the read image.

When a user recognizes a recording position on a medium, if the recording position is indicated on an actual medium, it is possible to most suitably suppress the deviation between the recording position which is recognized by the user and the actual recording position.

However, in JP-A-2005-41146, there is no description or a suggestion regarding the indication of the recording position on the actual medium before the recording. That is, in the recording apparatus in JP-A-2005-41146, the recording position is not indicated on the medium before the recording. Therefore, for example, there is a concern that the deviation may occur between the recording position recognized by the user from the read image (image on digital data) displayed on a monitor (a display unit) and the actual recording position.

### SUMMARY

Therefore, an advantage of some aspects of the invention is to suppress the occurrence of the deviation between the recording position assumed from the digital data and the actual recording position.

According to a first aspect of the invention, there is provided a recording apparatus that includes a support unit that can support and move a medium toward the moving direction, a recording unit that records an image on the medium supported by the support unit based on digital data, and a projection unit that projects an object which is a reference of a recording position, on the medium on the medium supported by the support unit.

In the recording apparatus in a second aspect of the invention, a change of the recording position in the digital data may be accepted, and then, a projection position of the object may be changed in correspondence with the change of the recording position.

In the recording apparatus in a third aspect of the invention, the projection position of the object may be changed, and the recording position in the digital data may be changed in correspondence with the change of the projection position of the object.

In the recording apparatus in a fourth aspect of the invention, the projection unit may include a first projection unit and a second projection unit. The first projection unit may project a first object among the objects corresponding to one end of the recording position in one direction among the moving direction and a crossing direction intersecting the moving direction, and the second projection unit may project a second object among the objects corresponding to the other end of the recording position in the one direction.

In the recording apparatus in a fifth aspect of the invention, a size of the image recorded on the medium may be changed in correspondence with a distance between the one end and the other end in the one direction.

In the recording apparatus in a sixth aspect of the invention, the projection unit may include a third projection unit and a fourth projection unit. The third projection unit may project a third object among the objects corresponding to one end of the recording position in the other direction among the moving direction and the crossing direction, and the fourth projection unit may project a fourth object among the objects corresponding to the other end of the recording position in the other direction.

According to a seventh aspect of the invention, there is provided a projection method for projecting a recording position in a recording apparatus that includes that includes a support unit that can support and move a medium toward the moving direction, and a recording unit that records an image on the medium supported by the support unit based on digital data. The method includes projecting an object which is a reference of a recording position on the medium, on the medium supported by the support unit.

According to the invention, it is possible to suppress the occurrence of the deviation between the recording position assumed from the digital data and the actual recording position.

### BRIEF DESCRIPTION OF THE DRAWINGS

The invention will be described with reference to the accompanying drawings, wherein like numbers reference like elements.

FIG. 1 is a schematic perspective view of a recording apparatus in an embodiment of the invention.

FIG. 2 is a schematic perspective view of the recording apparatus in the embodiment of the invention.

FIG. 3 is a schematic front view of the recording apparatus in the embodiment of the invention.

FIG. 4 is a block diagram of the recording apparatus in the embodiment of the invention.

FIG. 5 is a schematic perspective view of a recording apparatus in the embodiment of the invention.

FIG. 6 is a schematic perspective view illustrating a main portion of the recording apparatus in the embodiment of the invention.

FIG. 7 is a schematic perspective view illustrating a medium support unit in the embodiment of the invention.

FIG. 8 is a schematic plan view illustrating an position of forming an image (recording position) on a medium set on the medium support unit of the recording apparatus in the embodiment of the invention.

FIG. 9 is a schematic diagram illustrating a display example of a position of forming an image I on the medium set on the medium support unit in a monitor of a PC which can be used with the recording apparatus in the embodiment of the invention.

### DESCRIPTION OF EXEMPLARY EMBODIMENTS

Hereinafter, a recording apparatus 1 in an embodiment of the invention will be described in detail with reference to drawings.

Firstly, an overview of the recording apparatus 1 in the present embodiment will be described.

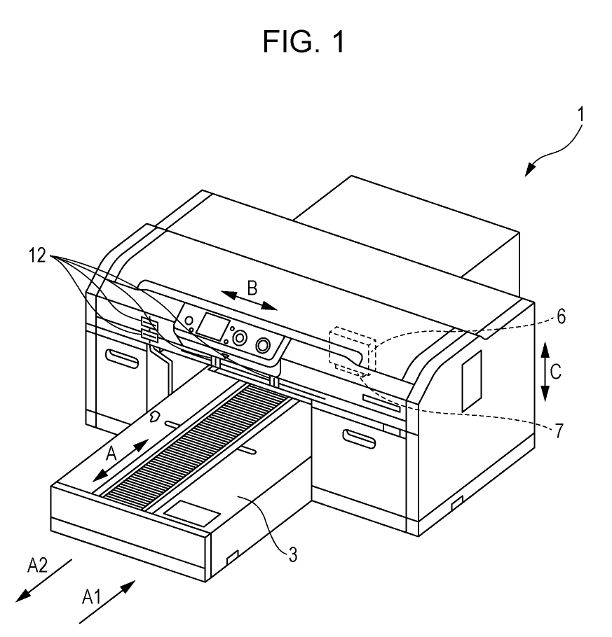

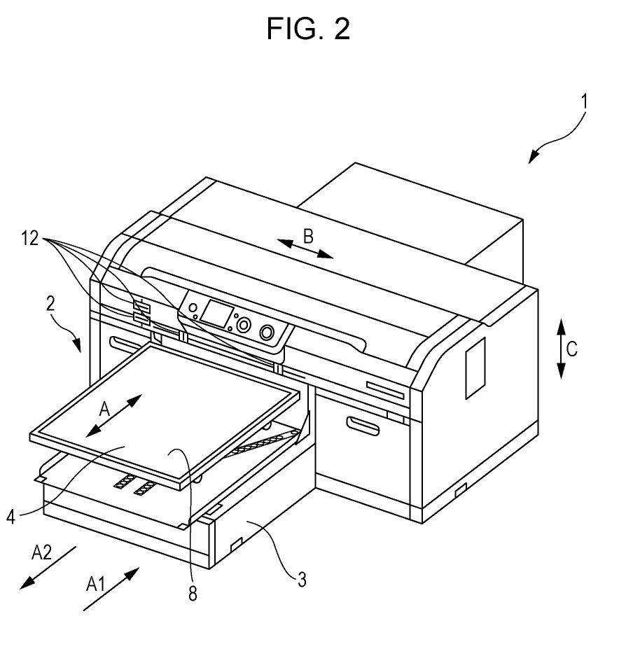

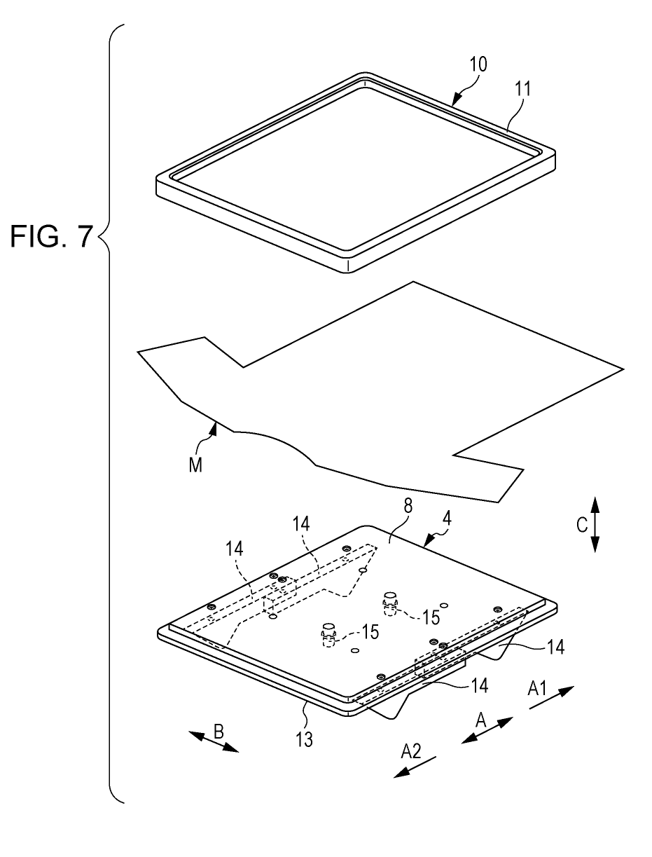

FIG. 1 and FIG. 2 are schematic perspective views of the recording apparatus 1 in an embodiment of the invention. FIG. 1 illustrates a state in which a tray 4 as a support unit of a medium M (refer to FIG. 7) of the recording apparatus 1 in the present embodiment is located at a recording start position, and FIG. 2 illustrates a state in which the tray 4 is located at a set position of the medium M.

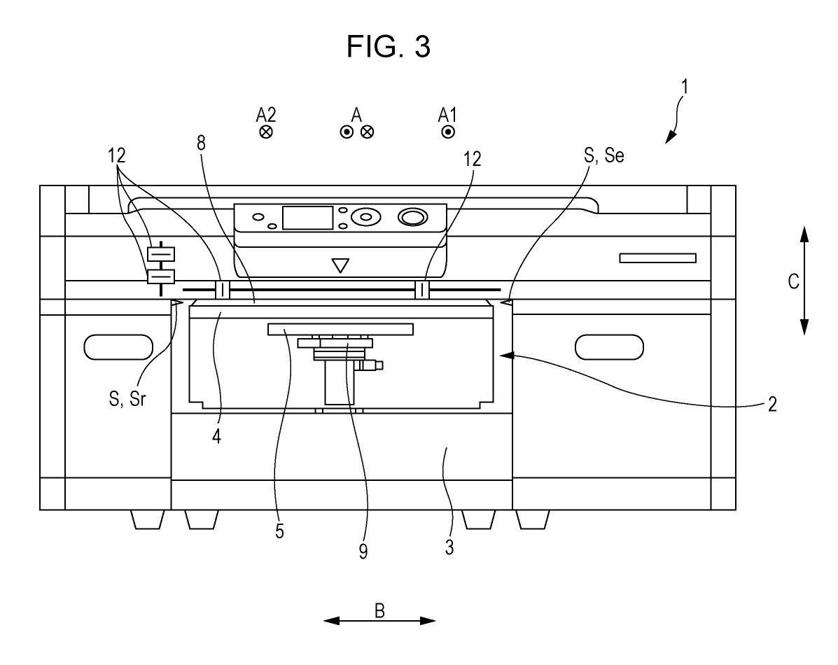

In addition, FIG. 3 is a schematic front view of the recording apparatus 1 in the present embodiment.

The recording apparatus 1 in the present embodiment includes a medium support unit 2 which moves toward a moving direction A in a state in which the medium M is supported by the support surface 8 of the tray 4. The medium support unit 2 includes the tray 4 which is a support unit of the medium M. The recording apparatus 1 includes a medium transportation unit 3 that transports the medium M supported by the tray 4 toward the moving direction A. The moving direction A is direction including a direction A1 and a direction A2 which is opposite to the direction A1. In addition, the tray 4 is mounted on a stage 5. The tray 4 moves to a height direction C together with the stage 5 by causing the rotation lever 9 to rotate. Various materials such as a textile (fabric, cloth or the like), a paper, or vinyl chloride resin can be used as the medium M.

In addition, a recording head 7 that can perform the recording on the medium M by discharging an ink is included in the main body of the recording apparatus 1. In the present embodiment, the recording head 7 corresponds to a recording unit that can execute the recording on the medium M. Then, the recording apparatus 1 in the present embodiment forms a desired image by discharging the ink on the medium M supported by the tray 4 from the recording head 7, while causing the recording head 7 to reciprocally moves in a crossing direction B by causing a carriage 6 on which the recording head 7 is provided to reciprocally moves in the crossing direction B intersecting a moving direction A.

In the recording apparatus 1 in the present embodiment, the front side (lower left direction) in FIG. 1 and FIG. 2 is a set position (corresponding to FIG. 2) of the medium M of the tray 4. Then, after moving the tray 4 on which the medium M is set to the recording start position (corresponding to FIG. 1) in the back side (upper right direction) in FIG. 1 and FIG. 2 to a direction A1 among the moving direction A, and then, the recording is performed with moving the tray 4 to the direction A2 among the moving direction A.

The recording head 7 that performs the recording with reciprocally moving in the crossing direction B is included in the recording apparatus 1 in the present embodiment. However, the recording apparatus may include a so-called line head having a plurality of nozzles that discharge the ink in the crossing direction B intersecting the moving direction A.

Here, the “line head” is a recording head used in a recording apparatus that forms an image by providing a region of the nozzles formed in the crossing direction B intersecting the moving direction A of the medium M so as to entirely cover the crossing direction B of the medium M, and then, by relatively moving the recording head or the medium M. The region of the nozzles in the crossing direction B of the line head may not entirely cover the crossing direction B of all the medium M that corresponds to the recording apparatus.

In addition, the recording head 7 in the present embodiment is the recording unit that can perform the recording by discharging the ink on the medium M. However, not being limited to this, a transfer type recording unit that performs the recording by transferring a color material to the medium M may be used.

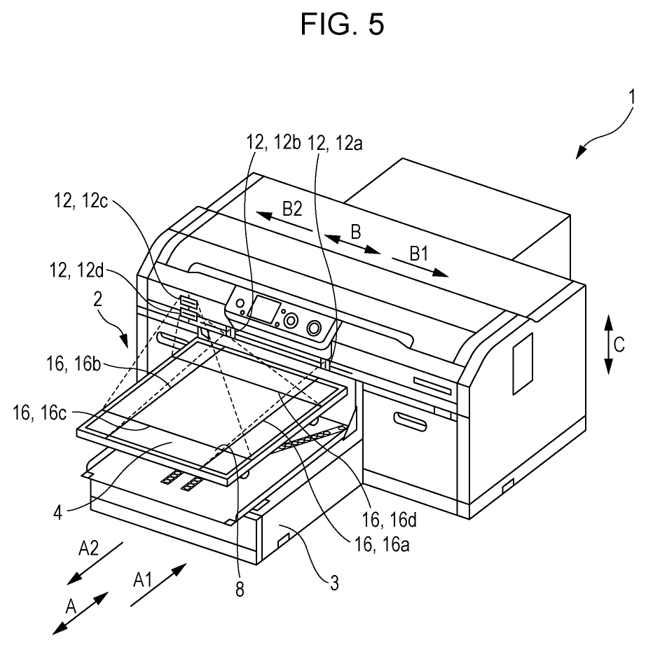

In addition, a projection unit 12 that projects a reference line 16 (refer to FIG. 5) as an object which is a reference for the recording position on the medium M is included on the medium M supported by the tray 4 of the recording apparatus 1 in the present embodiment. Details of the projection unit 12 will be described below.

In addition, as illustrated in FIG. 3, the recording apparatus 1 in the present embodiment includes a sensor S. Thus, in this configuration, it is possible to detect a presence or absence of an abnormality (the gap between the medium M and the recording head 7 becomes narrow or the like) in a gap between the medium M supported by the tray 4 and the recording head 7.

Here, the sensor S includes a light emission unit Se and a light reception unit Sr. Then, by irradiating a light from the light emission unit Se toward the light reception unit Sr, the sensor S can detect the presence or absence of the abnormality in the gap based on whether or not the light is received by the light reception unit Sr. However, the configuration is not limited to the configuration described above.

Next, an electrical configuration of the recording apparatus 1 in the present embodiment will be described.

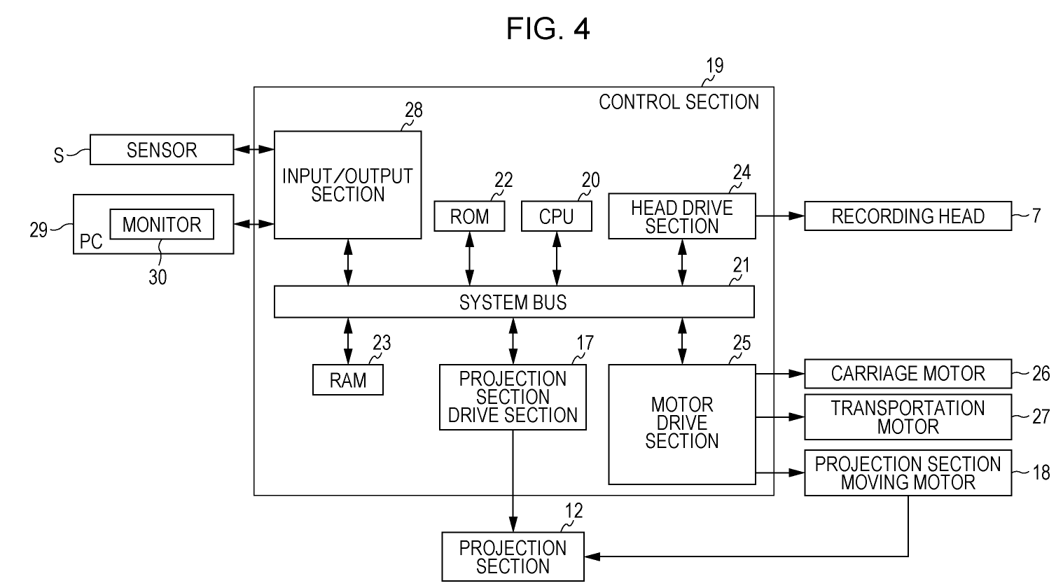

FIG. 4 is block diagram of the recording apparatus 1 in the present embodiment.

A CPU 20 that controls the entire recording apparatus 1 is provided in a control unit 19. The CPU 20 is connected to a ROM 22 in which various program executed by the CPU 20 is stored and a RAM 23 in which data can temporary be stored, via a system bus 21.

In addition, the CPU 20 is connected to a head drive unit 24 via the system bus 21 for driving the recording head 7.

In addition, the CPU 20 is connected to a projection unit drive unit 17 via the system bus 21 for driving (irradiating the light from the projection unit 12 and projecting the reference line 16) the projection unit 12.

In addition, the CPU 20 is connected to a motor drive unit 25 via the system bus 21. Then, the motor drive unit 25 is connected to a carriage motor 26 for moving the carriage 6 on which the recording head 7 is provided, a transportation motor 27 provided on the medium transportation unit 3 for transporting the medium M, and a projection unit moving motor 18 for moving the projection unit 12.

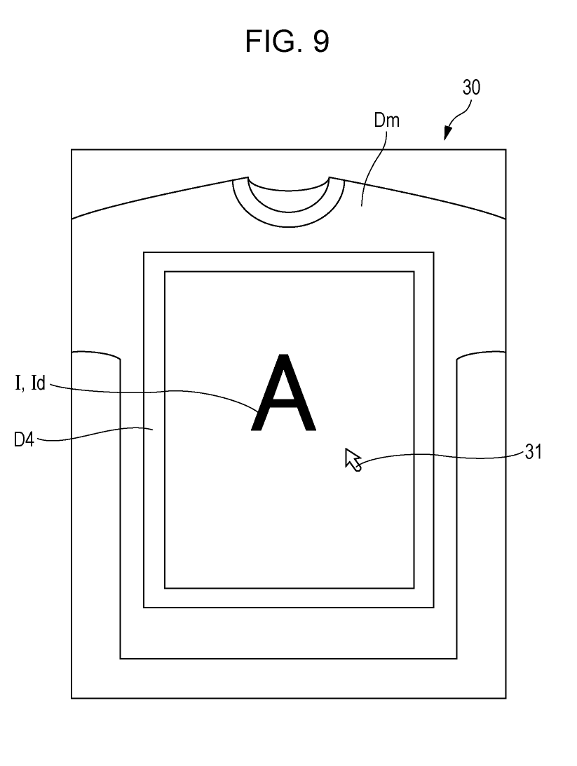

Furthermore, the CPU 20 is connected to an input/output unit 28 via the system bus 21, and the input/output unit 28 includes the sensor S and a monitor 30 as a display unit and is connected to a PC 29 that performs a transmission and reception of data and signals such as an image data Id (refer to FIG. 9) as digital data of the image I.

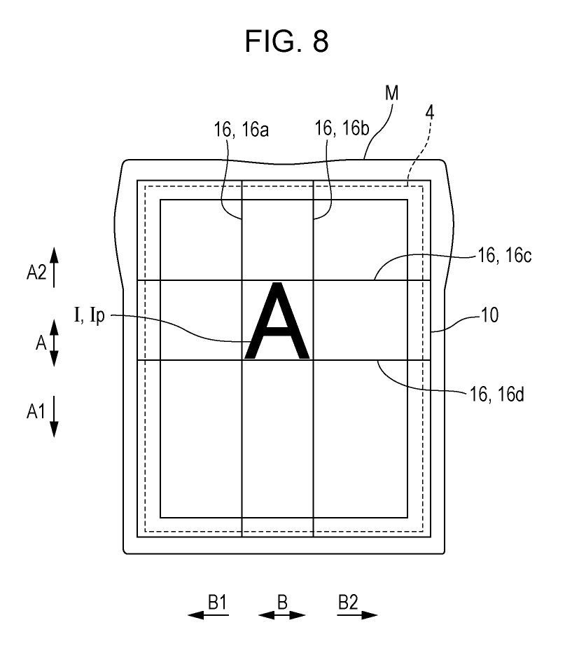

As described above, the recording apparatus 1 in the present embodiment includes the tray 4 that can move toward the moving direction A while supporting the medium M and the recording head 7 that records the image I on the medium M which is supported by the tray 4. Here, the recording head 7 can record the image I (recorded image Ip (refer to FIG. 8)) by the control of the control unit 19 based on the digital data (image data Id) having recording position information.

In addition, as described above, the recording apparatus 1 in the present embodiment includes the projection unit 12. Here, the projection unit 12 can project the reference line 16 on the medium M supported by the tray 4 as the object which is a reference of the recording position on the medium M. By this configuration, in the recording apparatus 1 in the present embodiment, it is possible to indicate the recording position on the actual medium M before the recording. That is, in this configuration, it is possible to suppress the occurrence of deviation between the recording position assumed from the digital data (for example, position (refer to FIG. 9)) of the image data Id in the data displayed on the monitor 30 on a medium Dm and the recording position of the image I (recorded image Ip) on the actual medium M. In other words, by the method of projecting the reference line 16 using the recording apparatus 1 in the present embodiment, the recording position can be indicated on the actual medium M before the recording, and thus, it is possible to suppress the occurrence of the deviation between the recording position assumed from the digital data and the recording position of the image I on the actual medium M.

Next, the projection unit 12 which is a main portion of the recording apparatus 1 in the present embodiment will be described.

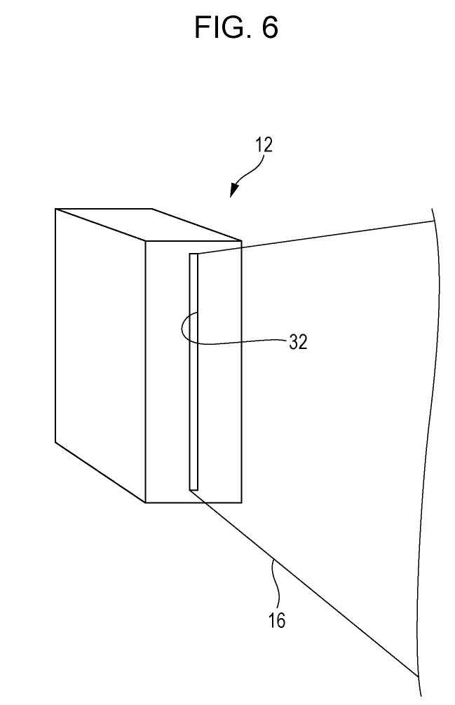

Here, FIG. 5 is a schematic perspective view of the recording apparatus 1 in the present embodiment, and a state in which the projection unit 12 projects the reference line 16 is illustrated. In addition, FIG. 6 is a schematic enlarged view illustrating the projection unit 12 in the embodiment of the invention.

As illustrated in FIG. 5, the recording apparatus 1 in the present embodiment includes a first projection unit 12a and a second projection unit 12b as the projection unit 12, which can move in the crossing direction B and can project the light beam (reference line 16) along the moving direction A. By moving in the crossing direction B, the first projection unit 12a and the second projection unit 12b can project the reference line 16 on the medium M supported by the tray 4, which is the reference of the recording position in the crossing direction B in the medium M.

Here, the first projection unit 12a can project a first object 16a among the reference line 16, which corresponds to an end (top side in the direction B1) of the recording position in the crossing direction B which is one direction among the moving direction A and the crossing direction B intersecting the moving direction A. The second projection unit 12b can project a second object 16b among the reference line 16, which corresponds to the other end (top side in the direction B2) of the recording position in the crossing direction B which is one direction among the moving direction A and the crossing direction B intersecting the moving direction A.

That is, the recording apparatus 1 in the present embodiment projects a recording region in the crossing direction B by the first object 16a and the second object 16b. For this reason, in this configuration, the recording region in the crossing direction B becomes clear, and thus, it is possible to effectively suppress the occurrence of the deviation between the recording position assumed from the digital data and the actual recording position.

In addition, as illustrated in FIG. 5, the recording apparatus 1 in the present embodiment includes a third projection unit 12c and a fourth projection unit 12d as the projection unit 12, which can move in a height direction C and can project the light (reference line 16) along the crossing direction B. By moving in the height direction C, the third projection unit 12c and the fourth projection unit 12d can project the reference line 16 on the medium M supported by the tray 4, which is the reference of the recording position in the moving direction A in the medium M.

Here, the third projection unit 12c can project a third object 16c among the reference line 16, which corresponds to an end (top side in the direction A2) of the recording position in the moving direction A which is the other direction among the directions of the moving direction A and the crossing direction B intersecting the moving direction A. The fourth projection unit 12d can project a fourth object 16d among the reference line 16, which corresponds to the other end (top side in the direction Al) of the recording position in the moving direction A which is the other direction among the moving direction A and the crossing direction B intersecting the moving direction A.

That is, the recording apparatus 1 in the present embodiment projects a recording region in the crossing direction B by the first object 16a and the second object 16b, and projects a recording region in the moving direction A by the third object 16c and the fourth object 16d. For this reason, in this configuration, the recording regions in the moving direction A and the crossing direction B become clear, and thus, it is possible to further effectively suppress the occurrence of the deviation between the recording position assumed from the digital data and the actual recording position.

In the present embodiment, the objects 16 corresponding to one end and the other end of the recording position in the crossing direction B are the first object 16a and the second object 16b, and the objects 16 corresponding to one end and the other end of the recording position in the moving direction A are the third object 16c and the fourth object 16d.

However, the correspondence relationship between the first object 16a and the second object 16b, and the correspondence relationship between the third object 16c and the fourth object 16d (that is, the correspondence relationship between the first projection unit 12a and the second projection unit 12b, and the correspondence relationship between the third projection unit 12c and the fourth projection unit 12d) may be reversed.

Furthermore, the correspondence relationships between the first object 16a and the second object 16b and the third object 16c and the fourth object 16d (that is, the correspondence relationships between the first projection unit 12a and second projection unit 12b and the third projection unit 12c and the fourth projection unit 12d) may be reversed.

Here, the shapes of the projection unit 12 (the first projection unit 12a, the second projection unit 12b, the third projection unit 12c, and the fourth projection unit 12d) in the present embodiment are all the same, and the shape is illustrated in FIG. 6. That is, the projection unit 12 in the present embodiment includes a light beam source therein and a straight line-shaped slit 32 is provided. By a configuration like this, a straight line-shaped light beam can be projected as the reference line 16. Then, the first projection unit 12a and the second projection unit 12b are disposed such that the direction of the straight line-shaped light beam is along the moving direction A and is projected on the medium M supported by the tray 4, and the third projection unit 12c and the fourth projection unit 12d are disposed such that the direction of the straight line-shaped light beam is along the crossing direction B and is projected on the medium M supported by the tray 4. Here, for example, a light-emitting diode or the like can be used as the light beam source, but is not particularly limited thereto. In addition, the strength or the wavelength of the light is not particularly limited, but it is preferable that there is no influence even when the light comes into the eyes.

The projection unit 12 in the present embodiment has a configuration in which the straight line-shaped reference line 16 can be projected as the object which is the reference of the recording position on the medium M, but may not be the straight line-shaped reference line. For example, the shapes of each of the first object 16a, the second object 16b, the third object 16c, and the fourth object 16d may have L shape or cross shape so as to form four corners of the recording region. However, it is preferable that the straight line-shaped reference line easily checks the recording region and the object is the straight line-shaped reference line.

In addition, when setting the medium M on the tray 4, if the projection is performed in advance such that the center portion of the tray 4 can easily be recognized by the reference line 16 (that is, the center portion of the support unit is projected by the object in advance), it becomes easy to recognize the set position of the medium M on the tray 4.

Next, the medium support unit 2 in an embodiment of the invention will be described.

Here, FIG. 7 is a schematic perspective view illustrating the medium support unit 2 in the present embodiment of the invention.

As illustrated in FIG. 7, the medium support unit 2 in the present embodiment includes the tray 4 as the support unit that can support the medium M and a frame-shaped pressing unit 10 which can press the medium M supported by the tray 4.

Then, in this configuration, the medium M is supported by the support surface 8 of the tray 4 and an eaves unit 11 of the pressing unit 10 is mounted on an edge portion 13 of the tray 4, and thus, the pressing unit 10 can press the medium M.

An installation unit 14 removed from the stage 5 for being installed on a floor and a position determination unit 15 which can determine a position with respect to the stage 5 are included in the tray 4 in the present embodiment.

However, the configurations of the pressing unit 10 and the tray 4 are not particularly limited.

In addition, the recording apparatus 1 in the present embodiment can form the desired image I on the desired position on the medium M supported by the tray 4 (the medium support unit 2) by using driver software (a program) of the recording apparatus 1 installed in the PC 29.

Here, the way how the user can form the desired image I on the desired position on the medium M supported by the medium support unit 2 using a recording unit in the present embodiment will be described using FIG. 8 and FIG. 9.

Here, FIG. 8 is a schematic plan view illustrating the position of forming the image I (recorded image Ip) on a medium M set on the medium support unit 2 of the recording apparatus 1 in the present embodiment of the invention. FIG. 9 is a schematic diagram illustrating a position of forming the image I on the medium M set on the medium support unit 2 in the monitor 30 of the PC 29 which can be used with the recording apparatus 1 in the embodiment of the invention.

When the user executes the driver software in the PC 29, as illustrated in FIG. 9, the image data Id of the image I desired to be recorded is displayed on the monitor 30 together with the displaying of the medium Dm in the data supported by the tray D4 in the data.

On the other hand, in the actual medium M supported by the tray 4, as illustrated in FIG. 8, the reference line 16 (the first object 16a, the second object 16b, the third object 16c, and the fourth object 16d) is projected. In FIG. 8, the image I (recorded image Ip) corresponding to the data image Id desired to be recorded is indicated such that the position of the image I desired to be recorded can be easily known.

As illustrated in FIG. 8, the recording apparatus 1 in the present embodiment can indicate the recording region corresponding to the image data Id of the image I desired to be recorded, on the actual medium M supported by the tray 4 by projecting the reference line 16.

In addition, when receiving an instruction from the control unit 19 to change the recording position of the image data Id in the digital data (to change the recording position in the digital data), the recording apparatus 1 in the present embodiment can change a projection position of the reference line 16 (object) in correspondence with the change of the recording position. Specifically, the user can change the position of image data Id on the medium Dm in the data using a pointer 31 in the monitor 30 (change the position of the image data Id in FIG. 9). Then, in correspondence to the changed position, the control unit 19 performs the drive control of the projection unit moving motor 18, and then, the recording apparatus 1 in the present embodiment changes the projection position of the reference line 16 on the actual medium M (change the projection position of the reference line 16 in FIG. 8). In this way, by the user changing the recording position in the digital data, the recording apparatus 1 in the present embodiment can change the projection position of the reference line 16 to the position corresponding to the change. That is, by changing the recording position in the digital data on the monitor 30, the recording apparatus 1 in the present embodiment can simply change the projection position of the reference line 16 corresponding to the recording position on the medium M. Then, the recording apparatus 1 in the present embodiment can record the image I on the changed projection position (recording position).

“Changing the recording position in the digital data” is meant to include the changing of the image data Id itself in the digital data in addition to the changing of the recording position information in the digital data by changing the position of the image data Id using the pointer 30 without changing the image data Id as in the present embodiment.

In addition, the recording apparatus 1 in the present embodiment is configured such that user can manually move the projection unit 12 (the first projection unit 12a, the second projection unit 12b, the third projection unit 12c, and the fourth projection unit 12d) to an arbitrary position. For this reason, the user can manually change the projection position of the reference line 16 to the arbitrary position (changing the projection position of the reference line 16 in FIG. 8). Then, the recording apparatus 1 in the present embodiment can automatically change the recording position of the image data Id in the digital data by the control of the control unit 19 in correspondence with the change of the projection position of the reference line 16 (the change of the position of the image data Id in FIG. 9). Therefore, by changing the recording position on the actual medium M before the recording, it is possible to simply change the digital data so as to be recorded on the changed position.

The recording apparatus 1 in the present embodiment is configured such that the projection position of the object 16 can be changed by moving the projection unit 12. However, the configuration is not limited thereto, but may be configured such that the projection position can be changed by changing the posture or the direction of the projection unit 12 without moving the projection unit 12.

In addition, as a result of changing the projection position of the reference line 16, the recording apparatus 1 in the present embodiment can perform the recording by changing the size of the image I desired to be recorded. That is, for example, the size of the image I recorded on the medium M can be enlarged by widening the gap between the first object 16a and the second object 16b, and the size of the image I recorded on the medium M can be reduced by narrowing the gap. In other words, it is possible to change the size of the image I recorded on the medium M in correspondence with the distance from one end to the other end in the crossing direction B which is the one direction described above.

According to the configuration described above, by changing the projection position of the first object 16a and the second object 16b, the recording apparatus 1 in the present embodiment can simply record the image I on the arbitrary position on the medium M with enlarging or reducing the size of the image I.

In addition, in the recording apparatus 1 in the present embodiment, the size of the image I recorded on the medium M may be enlarged by widening the gap between the third object 16c and the fourth object 16d, and the size of the image I recorded on the medium M may be reduced by narrowing the gap. According to the configuration described above, by changing the projection position of the third object 16c and the fourth object 16d, it is possible to simply record the image I on the arbitrary position on the medium M with enlarging or reducing the size of the image I.

The invention is not limited to the embodiment described above, and various modifications can be made with the scope of the invention disclosed in the aspects of the invention, and it is needless to say that the modifications also be included in the scope of the invention.

As above, the invention is described in detail based on the embodiment. Here, the invention will be summarized again.

The recording apparatus 1 in a first aspect of the invention includes the support unit 4 that can support and move the medium M toward the moving direction A, the recording unit 7 that records the image I on the medium M supported by the support unit 4 based on digital data, and the projection unit 12 that projects the object 16 which is a reference of a recording position on the medium M on the medium M supported by the support unit 4.

According to this aspect, the projection unit 12 that projects the object 16 on the medium M supported by the support unit 4, which is a reference of the recording position on the medium M. For this reason, it is possible to indicate the recording position on the actual medium M before recording. Therefore, it is possible to suppress the occurrence of the deviation between the recording position assumed from the digital data and the actual recording position.

In the recording apparatus 1 in a second aspect of the invention, according to the first aspect of the invention, a change of the recording position of image data in the digital data may be accepted, and then, a projection position of the object 16 may be changed in correspondence with the change of the recording position.

According to this aspect, the change of the recording position of image data in the digital data is accepted and the projection position of the object 16 is changed. That is, the recording position in the digital data is changed, and then, the projection position of the object 16 is changed in correspondence with the change. Therefore, for example, by changing the recording position in the digital data on the display unit 30, the projection position of the object 16 corresponding to the recording position on the medium M can simply be changed.

In the recording apparatus 1 in a third aspect of the invention, according to the first aspect or the second aspect of the invention, the projection position of the object 16 may be changed, and the recording position in the digital data may be changed in correspondence with the change of the projection position of the object 16.

According to this aspect, the projection position of the object 16 can be changed, and thus, and the recording position in the digital data is changed in correspondence with the change of the projection position of the object 16. Therefore, by changing the recording position on the actual medium M before the recording, it is possible to simply change the digital data so as to be recorded on the changed position.

“The projection position of the object 16 can be changed” is meant to include the configuration in which the projection position of the object 16 can be changed by moving the projection unit 12 in addition to the configuration in which the projection position is changed by changing the posture or the direction of the projection unit 12 without moving the projection unit 12.

In the recording apparatus 1 in a fourth aspect of the invention, according to any one of the first aspect to the third aspect of the invention, the projection unit 12 may include a first projection unit 12a and a second projection unit 12b. The first projection unit 12a may project a first object 16a among the objects 16 corresponding to one end of the recording position in one direction among the moving direction A and a crossing direction B intersecting the moving direction A. The second projection unit 12b may project a second object 16b among the objects 16 corresponding to the other end of the recording position in the one direction.

According to this aspect, the projection unit 12 includes the first projection unit 12a and the second projection unit 12b. The first projection unit 12a projects the first object 16a among the objects 16 corresponding to one end of the recording position in one direction. The second projection unit 12b projects the second object 16b among the objects 16 corresponding to the other end of the recording position in the one direction. That is, the recording region in the one direction is projected by the first object 16a and the second object 16b. Therefore, the recording region in the one direction becomes clear, and thus, it is possible to effectively suppress the occurrence of the deviation between the recording position assumed from the digital data and the actual recording position.

In the recording apparatus 1 in a fifth aspect of the invention, according to the fourth aspect or the fifth aspect of the invention, a size of the image I recorded on the medium M may be changed in correspondence with a distance between the one end and the other end in the one direction.

According to this aspect, the size of the image I recorded on the medium M is changed in correspondence with a distance between the one end and the other end in the one direction. Therefore, by changing the projection position of the first object 16a and the second object 16b, the image I can simply be recorded on the arbitrary position on the medium M with enlarging or reducing the size of the image I.

In the recording apparatus 1 in a sixth aspect of the invention, according to the fourth aspect or the fifth aspect of the invention, the projection unit 12 may include a third projection unit 12c and a fourth projection unit 12d. The third projection unit 12c may project the third object 16c among the objects 16 corresponding to one end of the recording position in the other direction among the moving direction and the crossing direction. The fourth projection unit 12d may project the fourth object 16d among the objects 16 corresponding to the other end of the recording position in the other direction.

According to this aspect, the projection unit 12 includes a third projection unit 12c and a fourth projection unit 12d. The third projection unit 12c projects the third object 16c among the objects 16 corresponding to one end of the recording position in the other direction among the moving direction and the crossing direction. The fourth projection unit 12d projects the fourth object 16d among the objects 16 corresponding to the other end of the recording position in the other direction. That is, the recording region in the one direction is projected by the first object 16a and the second object 16b and the recording region in the other direction is projected by the third object 16c and the fourth object 16d. Therefore, the recording regions in the one direction and in the other direction become clear, and thus, it is possible to effectively suppress the occurrence of the deviation between the recording position assumed from the digital data and the actual recording position.

A projection method in a seventh aspect of the invention is for projecting the recording position in the recording apparatus 1 that includes the support unit 4 that can support and move the medium M toward the moving direction A, and a recording unit 7 that records an image I on the medium M supported by the support unit 4 based on digital data. The method includes projecting the object 16 which is a reference of a recording position on the medium M on the medium M supported by the support unit 4.

According to the aspect, the object 16 which is a reference of a recording position on the medium M is projected on the medium M supported by the support unit 4. For this reason, the recording position can be indicated on the actual medium M before the recording. Therefore, it is possible to suppress the occurrence of the deviation between the recording position assumed from the digital data and the actual recording position.

The entire disclosure of Japanese Patent Application No. 2015-059164, filed Mar. 23, 2015 is expressly incorporated reference herein.

What is claimed is:

1. A recording apparatus comprising:
a support unit that can support and move a medium toward the moving direction;
a recording unit that records an image on the medium supported by the support unit based on digital data; and
a projection unit that projects an object which is a reference of a recording position on the medium, on the medium supported by the support unit.

2. The recording apparatus according to claim 1,
wherein, a change of the recording position in the digital data is accepted, and then, a projection position of the object is changed in correspondence with the change of the recording position.

3. The recording apparatus according to claim 1,
wherein the projection position of the object can be changed, and
wherein the recording position in the digital data is changed in correspondence with the change of the projection position of the object.

4. The recording apparatus according to claim 1,
wherein the projection unit includes a first projection unit and a second projection unit, and
wherein the first projection unit projects a first object among the objects corresponding to one end of the recording position in one direction among the moving direction and a crossing direction intersecting the moving direction, and
wherein the second projection unit projects a second object among the objects corresponding to the other end of the recording position in the one direction.

5. The recording apparatus according to claim 4,
wherein a size of the image recorded on the medium is changed in correspondence with a distance between the one end and the other end in the one direction.

6. The recording apparatus according to claim 4,
wherein the projection unit includes a third projection unit and a fourth projection unit,
wherein the third projection unit projects a third object among the objects corresponding to one end of the recording position in the other direction among the moving direction and the crossing direction, and
wherein the fourth projection unit projects a fourth object among the objects corresponding to the other end of the recording position in the other direction.

7. A projection method for projecting a recording position in a recording apparatus that includes a support unit that can support and move a medium toward the moving direction, and a recording unit that records an image on the medium supported by the support unit based on digital data, the method comprising:
projecting an object which is a reference of a recording position on the medium, on the medium supported by the support unit.
